(19) United States
(12) Patent Application Publication
(10) Pub. No.: US 2019/0337310 A1
(43) Pub. Date: Nov. 7, 2019

(54) METHOD AND SYSTEM FOR INTELLIGENT DRYING IN CUT-SHEET AQUEOUS INK JET PRINTING SYSTEMS

(71) Applicant: Xerox Corporation, Norwalk, CT (US)

(72) Inventor: Seemit Praharaj, Webster, NY (US)

(73) Assignee: Xerox Corporation

(21) Appl. No.: 15/972,193

(22) Filed: May 6, 2018

(51) Int. Cl. B41J 11/00; B41J 29/393; B41M 7/00

(52) U.S. Cl. CPC B41J 11/0095; B41M 7/009; B41J 29/393; B41J 11/002

(57) ABSTRACT

Methods and systems for facilitating drying of media in a high-speed digital printer (e.g., a cut-sheet aqueous ink jet printing system). The high-speed digital printer includes a dryer module composed of a group of dryers that dry media including the test media. In an example embodiment, a series of test media can be printed at increasingly higher ink loading. The moisture content of the test media is monitored at each exit of each dryer to generate data indicative of the threshold at which the dryer module is no longer able to effectively dry the test media. Data resulting from such moisture content monitoring is fed to a marking engine and/or image path of the high-speed digital printer to generate a linearization profile in-situ. Such a linearization profile includes ink volume limiting linearization data that is used to ensure that media exiting the dryer module are dry.

### TECHNICAL FIELD

Embodiments are generally related to printers including high speed printing systems such as cut-sheet aqueous ink jet printing systems. Embodiments further relate to dryers utilized for drying media in printing systems.

### BACKGROUND

Imaging devices such as inkjet printers typically operate one or more print heads that are configured to eject ink for marking media. In direct marking printers, the ink is applied directly to the media, rather than to an intermediate printing surface. The media can be, for example, a surface of a continuous web of media material, a series of media sheets, or other surfaces that are desirably marked. A print head controller typically controls the print head (or print heads) by generating a firing signal with reference to image data.

High speed printing systems are typically configured as continuous web printers such as cut sheet systems in which a supply of media is provided in a large roll that is unwound by one or more actuators that pull media from the roll and propel it through the printing system. The web passes an arrangement of print heads that eject ink or other materials onto the media as the web passes the print heads to form images on the web. Two or more print heads can be mounted to a support structure to form an array of print heads that extends across the web in a cross-process direction. In these printers, print head arrays are arranged in the process direction, which is the direction in which the web moves past the print head arrays, and which is perpendicular to the cross-process direction.

Conventional printing systems and printing platforms lack the ability to produce high IQ (Image Quality) on a wide variety of coated stock (e.g., Glossy, Matte, Satin, Dull, IJ-treated and non IJ-treated). In addition, the prints that are made need to be completely dry while exiting the dryer and this remains one of the most critical challenges with using coated stock.

A simple solution involves overdesigning the printing system with multiple dryers to provide enough dwell time to completely dry any print exiting the system. This approach is based on consideration of the worst drying media to cover all possible scenarios. While this is the easiest solution, it is neither cost efficient nor energy efficient.

One of the parameters critical to producing high IQ prints is to ensure that the average amount of ink being put down on the media is specific to that particular media. For a given media, for example, too much ink gives rise to defects such as mottle and graininess as the ink is free to move around while it sits on top of the coated stock. Too little ink, on the other hand, causes the images to look desaturated (i.e., no vibrancy). As compared to uncoated media, there is also the additional issue of machine contamination (i.e., rollers, etc.) with ink if the prints exiting the dryer are not completely dry.

Conventional printers are equipped to run two kinds of media—uncoated and inkjet treated. Fortunately, the degree of variation in the optimized ink amount does not change significantly between these medias. In such a scenario, the user (e.g., a customer) is provided with the following two options. First, the customer can, for example, use a linearization profile that is pre-built in the machine for the drop size (e.g., small, medium, large) and media of interest. Some printer companies provide their customers with custom profiles for a reasonable number of uncoated and inkjet treated medias. Second, a custom linearization profile can be constructed for uncoated and/or inkjet treated media. The bounds of the ink limit to build such a profile is pre-set in the machine.

The ability to build a custom linearization profile for a media of their own choosing is very critical to the high-speed printer (e.g., digital printing press) customers today and it is what differentiates some conventional printing systems from their competitors who limit their customers to only the first option mentioned above.

The second option discussed above, however, remains a challenge. Providing the aforementioned second option to customers for coated stock is difficult with conventional printing techniques because of wildly different ink requirements for different types of media. As a result, tight bounds for the amount of ink cannot be established.

The resulting option is to establish loose bounds for the ink amount. This approach would be implemented in more of a trial and error sort of option where most often, the resulting prints will have too much ink and therefore will not be completely dry when exiting the dryer, which typically results in contamination of the printing systems' rollers.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved high speed printing methods and systems.

It is another aspect of the disclosed embodiments to provide for improved cut-sheet aqueous ink jet printing systems.

It is a further aspect of the disclosed embodiments to provide for an improved method and system for producing high IQ (Image Quality) renderings across a wide variety of coated media stock types (e.g., glossy, matte, satin, dull, IJ-treated, non IJ treated, etc).

It is also an aspect of the disclosed embodiments to provide for a high speed printing system (e.g., a digital press) in which prints that are made are completely dry when exiting the printing systems drying module.

It is an additional aspect of the disclosed embodiments to provide for methods and systems for intelligent drying in high speed printing systems such as a cut-sheet aqueous ink jet printer.

If is a further aspect of the disclosed embodiments to provided for methods and system for ensuring drying in cut-sheet aqueous ink jet printing systems.

The aforementioned aspects and other objectives and advantages can now be achieved as described herein. Methods and systems are disclosed for facilitating drying of media in a high-speed digital printer (e.g., a cut-sheet aqueous ink jet printing system). In an example embodiment, a series of test media can be printed at an increasingly higher ink loading. The high-speed digital printer generally includes a dryer module composed of a group of dryers that dry media including the test media. The moisture content of the test media is monitored at each exit of each dryer to generate data indicative of a threshold at which the dryer module is no longer able to effectively dry the test media. Data resulting from such moisture content monitoring is fed to a marking engine and/or image path of the high-speed digital printer to generate a linearization profile in-situ. Such a linearization profile includes ink volume limiting linearization data that is used to ensure that media exiting the dryer module are dry.

Additionally, a step or operation can be implemented for controlling power in the high-speed digital printer as a function of moisture based on feedback signals from a plurality of media moisture sensors wherein at least one respective media moisture sensor is installed a respective entrance and a respective exit of each dryer.

The disclosed embodiments provide for in-situ monitoring of media moisture content to allow both active dryer power setting control and the ability to construct ink limiting linearization profiles for specific media types by customers in real time. For the case of generating linearization profiles, a user or customer can print a series of test sheets at increasingly higher ink loading. As the sheets are printed, the sheet moisture content is monitored at a dryer exit to determine the point at which the dryer would no longer be able to effectively dry the sheets and feed this information/data back to the printer's marking engine/image path to generate an appropriate linearization profile. In the case of power control, media moisture sensors can be installed at the respective entrance and exit of each dryer zone and used as a feedback device to control dryer power as a function of moisture.

Benefits of the disclosed embodiments include the ability for a user or customer to generate ink volume limiting linearization tables in-situ to accommodate a wide range of media types and operating conditions. Also, actively controlling the dryer power can reduce run costs in that conventional dryers are sized and set to accommodate a worst-case dryer loading. The disclosed embodiments thus provide for a non-contact means of measurement, which when interfaced with machine functions results in enhanced printer performance and product output.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective pictorial view of a digital printing system, in accordance with an example embodiment;

FIG. 2 illustrates a side pictorial view of the digital printing system shown in FIG. 1, in accordance with an example embodiment;

FIG. 3 illustrates a block diagram of the digital printing system shown in FIGS. 1-2, in accordance with an example embodiment;

FIG. 4 illustrates a graph depicting data indicative of conductance versus residence time in accordance with an example embodiment;

FIG. 5 illustrates a graph of conductance versus residence time with respect to the elite gloss media, in accordance with an example embodiment;

FIG. 6 illustrates a block diagram depicting an example of a dryer module with a group of dryers for facilitating drying of media in a digital printing system, in accordance with an example embodiment;

FIG. 7 illustrates a high-level flow chart of operations depicting logical operational steps of a method for ensuring drying in a digital printing system, in accordance with an example embodiment;

FIG. 8 illustrates a schematic view of a computer system, in accordance with an embodiment; and

FIG. 9 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

Unless defined otherwise, all technical and scientific terms used herein have the same meanings as commonly understood by one of ordinary skill in the art. As used in this document, the term “comprising” means “including, but not limited to.”

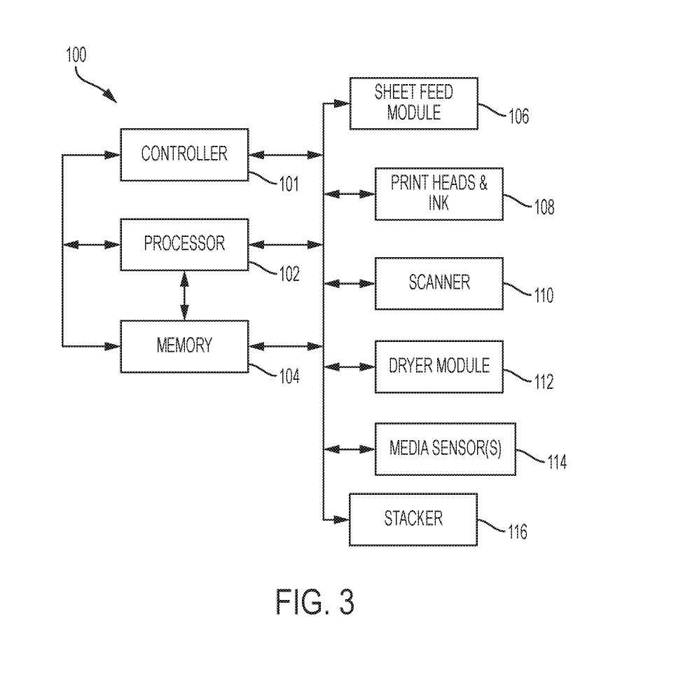

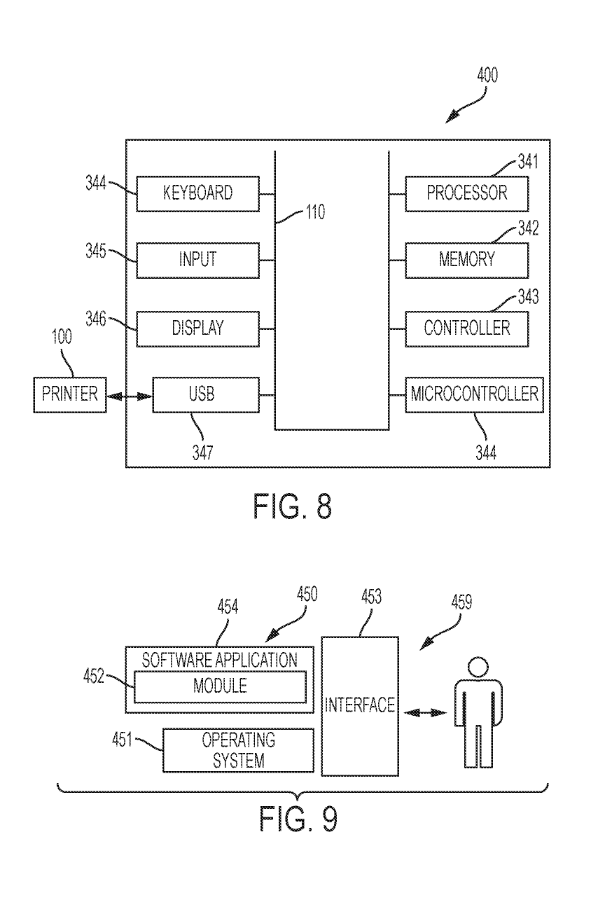

A “computing device” or “electronic device” or “data processing system” refers to a device or system that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players and the like. Various elements of an example of a computing device or processor are described below in reference to FIGS. 3 and 8.

As used herein, the term “printer” or “printing system” generally refers to a device for applying ink to media to form ink image on media or layering materials to form objects. The printer may include a variety of other components, such as finishers and paper feeders for ink image processing, and planerizers and curing devices for treatment of objects. An image on media or an object corresponds to image data stored in a memory in electronic form. The image data are rendered to generate electrical driving signals that are electrically connected to transducers that eject ink or materials from one or more print heads to form an image on media or an object in the printer. A marking engine renders the image data and such image data may include text, graphics, pictures, object layers and features, and the like. The term “media” can refer to a physical sheet of paper, plastic, or other suitable physical material that provides a surface for receiving ejected materials such as ink from an ink jet print head.

A “gap” or “gap distance” means a distance between a surface that receives ejected ink or material and a print head. The term “print head” refers to a single ink or material ejecting device or to a plurality of such devices arranged in an array of a print head assembly to cover either a cross-process width of a print surface in a printing device or a length of the print surface in the process direction. An “array,” “print head array,” and “print head assembly” means a plurality of print heads that are mounted to one or more members so they enable printing over a width or length that is larger than a single print head in the group of print heads can cover. A print head array can include a plurality of print heads that extend linearly in the cross-process width of the media, or can include a plurality of print heads that extend in a staggered fashion that generally extends in the cross-process direction. In some cases, a print head array extends across less than a full extent of the width of the media such as, for example, a print head array configured for different sized media such as envelopes or cards. An array can also include print heads configured in a series in the process direction to add either resolution or printing throughput capability.

A “print zone” means a volumetric space defined by a plane of the print surface of the media, a width of the print head(s) in which the print head(s) are configured to eject ink, and a height extending between a relatively small distance above a printing face of the print head(s) and at least the plane of the print surface. In an example, the height extends several millimeters above the nominal distance between the print head face and the material receiving surface, and can represent a height at which the print head(s) can eject material onto the surface with at least a predetermined threshold of accuracy.

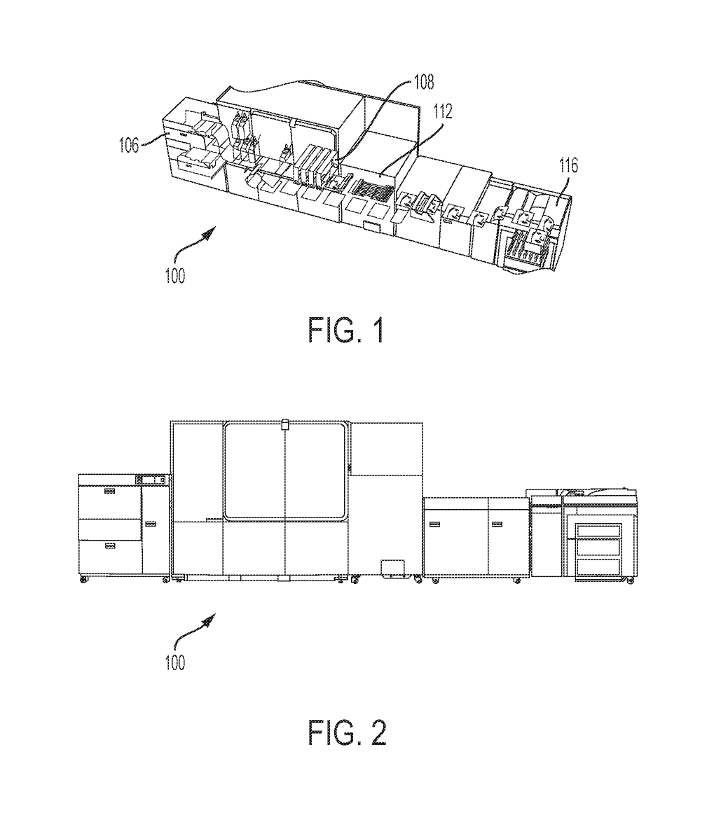

FIG. 1 illustrates a perspective pictorial view of a digital printing system 100, in accordance with an example embodiment. FIG. 2 illustrates a side pictorial view of the digital printing system shown 100 in FIG. 1, in accordance with an example embodiment. Note that in FIGS. 1-8 herein, identical or similar parts or elements are generally indicated by identical reference numerals. In an example embodiment, the digital printing system 100 can be implemented as a cut-sheet-aqueous ink jet printing system.

The digital printing system 100 (e.g., a high speed printing system) shown in FIG. 1 can be implemented as a digital printing press that includes a sheet feed module 106, a print head and ink module 108, a dryer module 112, and a production stacker 116. The print head and ink module 108 can be implemented in the context of a print zone that includes a print head array and a group of associated print heads and inks of different colors.

The sheet feed module 106 can hold, for example, 2500 sheets of stock media in each of two trays (for a total of, for example, 5000 sheets per unit) along with, for example, 4 possible feeders in the printing system configuration. In other words, the digital printing system 100 can offer a capacity of, for example, 20,000 sheets. Trays disposed in the sheet feed module 106 can hold paper of varying sizes. Each feeder that forms a part of the sheet feed module can be implemented with a shuttle vacuum feed head to pick a sheet off the top of the stack and deliver it to the transport.

The print head and ink module 108 can include a group of print heads (e.g., inkjet print heads) that capable of deliver ink drops of varying sizes through, for example, 7,870 nozzles per color to produce prints with, for example, a 600×600 dpi. The digital printing system can also be equipped with a scanner (e.g., see scanner 110 in FIG. 3) implemented as an integrated full-width scanner that enables automated print head adjustments, missing jet correction, and image-on-paper registration. An operator of the digital printing system 100 can, for example, make image quality improvements for special jobs such as edge enhancement, trapping, and black overprint. The digital printing system 100 is configured such that at all times automated checks and preventative measures maintain the system 100 in a ready state and operational.

After printing, the sheets move directly in the dryer module 112 where the paper and ink can be heated with one or more infrared carbon laps to approximately 90° C. (194° F.). This process facilitates the removal of moisture from the paper so that the sheets are stiff enough to move efficiently through the paper path. The drying process also removes moisture from the ink to prevent it from rubbing off. The digital printing system 100 includes a combination of sensors, thermostats, thermistors, thermopiles, and blowers that accurately assist in heating the fast-moving sheets and maintain a rated print speed.

The digital printing system 100 includes a finisher that runs continuously as the system 100 delivers, for example, 2,850 sheets at a time. Once unloaded, the stack tray returns to the main stack cavity to pick up and deliver another load—continuously. The stacker 116 (e.g., production stacker) can be configured with an adjustable height for unloading variations, and can also be configured with a by-bass path capability for rotating sheets to downstream devices. In addition, the stacker 116 can be configured with a, for example, 250-sheet top tray for sheet purge and samples, along with an optional production media cart for easy stack transport.

It can be appreciated that the particular digital printing system 100 discussed herein with respect to FIGS. 1-3 represents one possible printing system that can be adapted for use with the disclosed embodiments. The disclosed embodiments can be utilized with different types of digital print system embodiments. That is, the disclosed embodiments are not limited to use with the particular examples shown in FIGS. 1-3. A non-limiting example of a digital printing system that can be adapted for use with one or more of the disclosed embodiments is disclosed in U.S. Patent Application Publication No. 2017/0043585, entitled “System And Method To Maintain Print heads Operational In A Continuously Printing System,” which published on Feb. 16, 2017, and is incorporated herein by reference in its entirety. U.S. Patent Application Publication No. 2017/0043585 is based on U.S. patent application Ser. No. 14/824,221, which is assigned to Xerox Corporation.

Another non-limiting example of a digital printing system that can be adapted for use with one or more of the disclosed embodiments is the Xerox® Brenva™ HD Production Inkjet Press, which is disclosed in the brochure entitled “Xerox® Brenva™ HD Production Inkjet Press Overview,” which is incorporated herein by reference in its entirety.

FIG. 3 illustrates a block diagram of the digital printing system 100 shown in FIGS. 1-2, in accordance with an example embodiment. In some example embodiments, the digital printing system 100 can include a controller 101, a processor 102, and a memory 104. The controller 101 can communicate electronically with the memory 104 and the processor 102. The controller 101, the processor 102 and the memory 104 can also communicate electronically with the sheet feed module 106, the print head and ink module 108, the scanner 110, a dryer module 112, media sensors 114, and the stacker 116. In some example embodiments, the controller 101 may be configured as a controller that controllers the print heads of the print head and ink module 108. In still other example embodiments, the controller 101 can be configured to control the operations of the media sensor(s) 114 and power control for the overall system 100 or power control for specific components or print zones within the system 100.

The media sensor(s) 114 can include one or more sensors, such as, for example an optical sensor composed of a linear array of photo detectors and a light source. Such an optical sensor can be operatively connected to the controller 101. A moisture sensor is another example of a media sensor(s) 114.

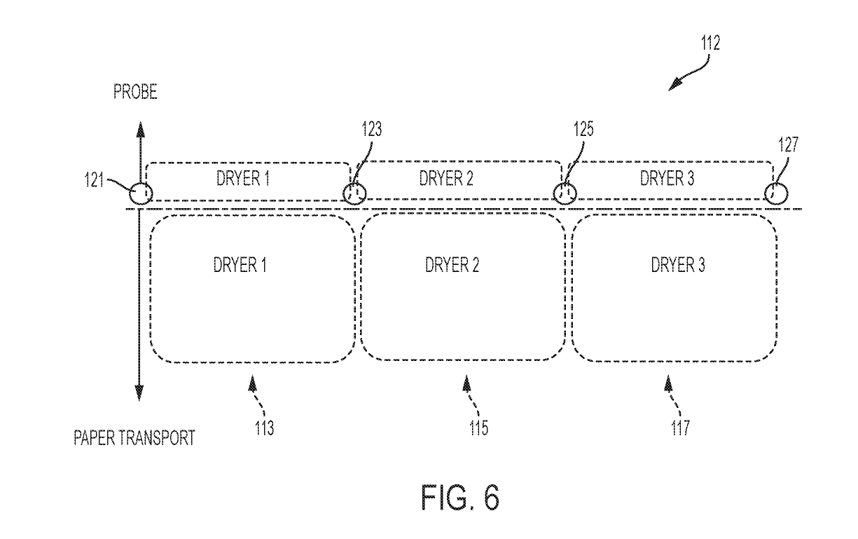

The controller 101 can be configured to receive signals generated by the media sensor(s) 114, and analyze the signals to detect, for example, an improper ejection of drops, and identify the particular print head assembly (e.g., print head and ink module 108) in which the print head having the malfunctioning ejector is located. Note that other examples of media sensors that can be utilized with the disclosed embodiments are the probes 121, 123, 125, and 127 depicted in FIG. 6. Such probes may be, for example, moisture sensors located at strategic locations with respect to the dryer module 112 as will be discussed in more detail herein.

In some example embodiments, each of the probes 121, 123, 125, and 127 depicted in FIG. 6 can be implemented as a non-contact eddy probe (e.g., an eddy current probe) that measures sheet resistance across the coated stock with printed ink on top. As will be discussed in greater detail herein, the idea location for locating such probes is before and/or after every dryer of the dryer module 112.

Note that an eddy current probe (also referred to as an eddy current sensor) uses the principle of eddy current formation to sense displacement. Eddy currents are formed when a moving or changing magnetic field intersects a conductor or vice versa. The relative motion causes a circulating flow of electrons, or currents, within the conductor. These circulating eddies of current create electromagnets with magnet fields that oppose the effect of applied magnetic field. The stronger the applied magnetic field, or greater the electrical conductivity of the conductor, or greater the relative velocity of motion, the greater the currents developed and greater the opposing field. Eddy current probes senses this formation of secondary fields to find out the distance between the probe and target material.

It should be appreciated that although the probes 121, 123, 125, and 127 depicted in FIG. 6 can be implemented as eddy probes or eddy current sensors, the disclosed embodiments are not limited to the use of such eddy probes as probes 121, 123, 125, and 127. That is, other types of sensing devices or probes can be utilized to implement probes 121, 123, 125, and 127.

Note that the processor 102 can be implemented as a CPU (Central Processing Unit), a microprocessor, a computer or data-processing system, and/or combinations thereof, and/or as any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. In addition, the controller 101 can include one or more processors that are configured to control operations, such as described herein. In some example embodiments, the controller 101 may be implemented as a microcontroller that communicates electronically with the processor 102, the memory 104 and so on.

It should be noted that the processors or controllers discussed herein may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the controller 101 and the processor 102 may represent processing circuitry such as one or more of a field programmable gate array (FPGA), application specific integrated circuit (ASIC), microprocessor(s), and/or the like. The circuits in various examples may be configured to execute one or more algorithms to perform functions, operations and logical operations as described herein. The one or more algorithms may include aspects of examples disclosed herein, whether or not expressly identified in a flowchart or a method.

In addition memory 104 and or/or other memory devices as discussed herein can be implemented as data storage units (one or more memories). A computer program can be stored in such memory 104 for execution by, for example, a computer, processor, controller, etc. Memory 104 can be, for example, RAM memory, ROM memory, EPROM memory, EEPROM memory, non-volatile RAM (NVRAM) memory and so on. The above data storage unit types are exemplary only, and are thus not limiting as to the types of memory usable for storage of a computer program.

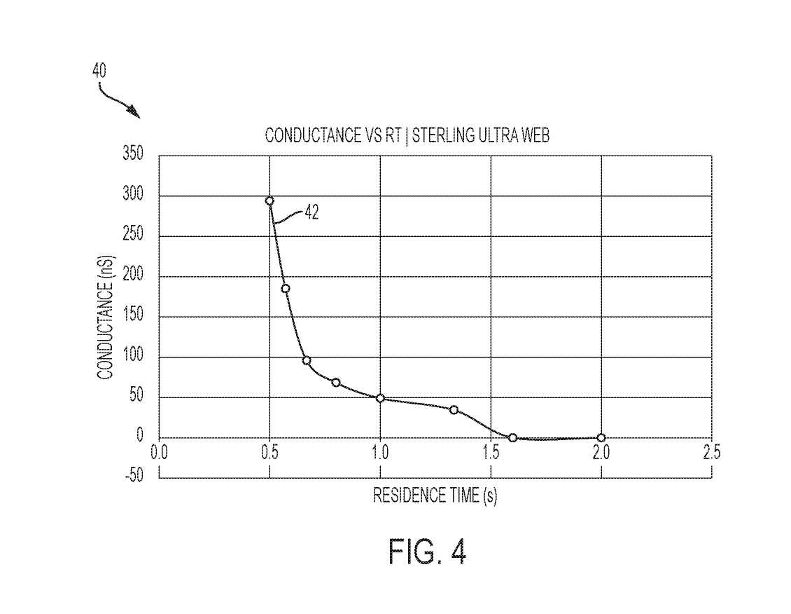

FIG. 4 illustrates a graph 40 depicting experimental data indicative of conductance versus residence time, in accordance with an example embodiment. During the time (e.g., the residence time) that a sheet is processed through the dryer module 112, the print becomes increasingly dry as the residence time is increased in the dryer module 112. A critical change takes place at, for example, 1 second where the prints become “dry to touch”. The plot 42 in graph 40 demonstrates the variation in conductance (1/resistance) across the same range of residence times. In graph 40, the residence time (s) is shown along the x-axis and the conductance (nS) along the y-axis.

For consistency, the resistance was measured across the same points and after the same amount of elapsed time after printing. As can be inferred from the plot 42 shown in graph 40, the conductance decreases exponentially as the print gets increasingly dry. A completely dry print exhibits 0 conductance. Thus, with the knowledge of resistance (or conductance) of the printed image one can predict the extent of drying.

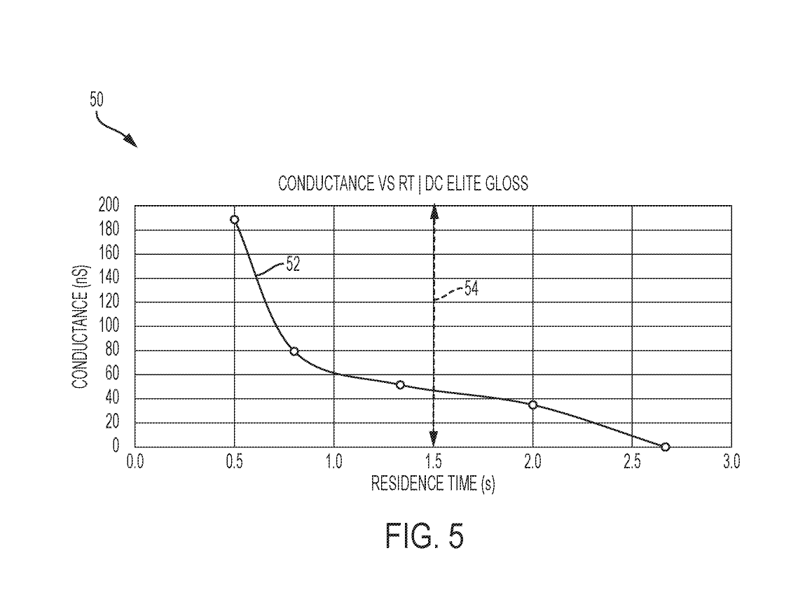

A similar test was performed for 100# DC Elite Gloss, one of the worst drying offset coated papers. The results from this test are shown in FIG. 5, which illustrates a graph 50 with a plot 52 of conductance versus residence time with respect to the aforementioned example elite gloss media, in accordance with an example embodiment. Using the previous test as a benchmark, a prediction can be made that the residence time required to dry this image is in excess of 1.5 seconds. This can be verified with a simple touch test to actually be the case.

The data contained in respective graphs 40 and 50 of FIGS. 4 and 5 can be derived from signals provided by the aforementioned non-contact eddy probes 121, 123, 125, and 127. That is, as discussed previously a non-contact eddy probe can be employed for measuring a sheet resistance across the coated stock with printed ink on top. A completely dry print would exhibit significantly higher resistance across the media as compared to a wet or a partially dry print. This difference in resistivity can be used to identify the extent of drying in an image exiting the dryer. This information can also be used to modulate the power settings in the dryer 113, 115, and 117 shown in FIG. 6 to achieve a ‘dry to touch’ printed image. The ideal location for such probe(s) is before and after every dryer. These steps may also be used as a calibration sequence each time a new media is introduced into the fixture to be printed on. The calibration sequence can progressively put down more ink on the media until the probe communicates that the final dryer is unable to dry the image. This thus fixes the maximum ink amount for the particular media. The ink amount can then be backed down from here to optimize the image quality via the linearization profile described herein.

FIG. 6 illustrates a block diagram depicting an example of a dryer module 112 having a group of dryers for facilitating drying of media in a digital printing system such as disclosed herein, in accordance with an example embodiment. The dryer module 112 can be composed of one or more of dryers 113, 115, 117 and so on. Current experiments by the inventors on test fixtures (PPID2, B03 etc.) have demonstrated that two dryers might not be enough to provide complete drying over a wide range of coated media. For purposes of the disclosed embodiments, a dryer module 112 is shown having three dryers 113, 115 and 117, although it can be appreciated that additional (or fewer) dryers may be implemented in accordance with varying embodiments. Ideally, for the example system discussed herein, four probes 121, 123, 125, and 127 can be placed before, after and between respective dryers 113, 115 and 117 and shown in FIG. 5.

Let us assume a customer desires to make prints on newly coated media. A specific sequence of steps can be followed as a part of a calibration step to acclimatize the system with this new media. As a part of this calibration step, progressively more ink may be placed down on the media to determine (via the probes 128, 123, 125, and 127) the maximum ink amount for the particular media that can be dried given the system configuration of the three dryers 113, 115, 117. Further, the operating conditions of the dryer module 112 may be optimized to provide the best possible drying performance. For example, for certain media types operating condition 1 (Dryer1: 100%|Dryer2: 75%|Dryer3: 100%) may offer a superior drying performance as compared to operating condition 2 (Dryer1: 100%|Dryer2: 100%|Dryer3: 100%).

Once the maximum ink limit is established, the next step involves determining the optimum ink amount to maximize the image quality for that media. For this step, linearization profiles can be constructed with knowledge of the maximum ink amount and the customer can determine which profile to use to get the best IQ (Image Quality) performance for that particular media type.

The use of probes such as probes 121, 123, 125, and 127 can also result in significant energy savings over time. Let us assume, for example, a particular job does not require dryer 117 (i.e., Dryer 3) to be operating at 100% for the entire time. This determination can be made from the first two probes 121 and 123 and can then be communicated to dryer 117 so that it may operate at the required level. The probes 121, 123, 125, and/or 127 can also help track dryer performance over time and enable preventative maintenance of the dryers where necessary.

Such probes can additionally help to prevent unnecessary system contamination. For example, if the last probe 127 determines that the prints being made are not dry, it can trigger a shutdown of the paper transport so that the wet ink does not get on any rollers. The print(s) in question can then be either removed or allowed to dry in situ before the next course of action. At the very least, this approach will prevent the entire system from becoming contaminated with wet ink.

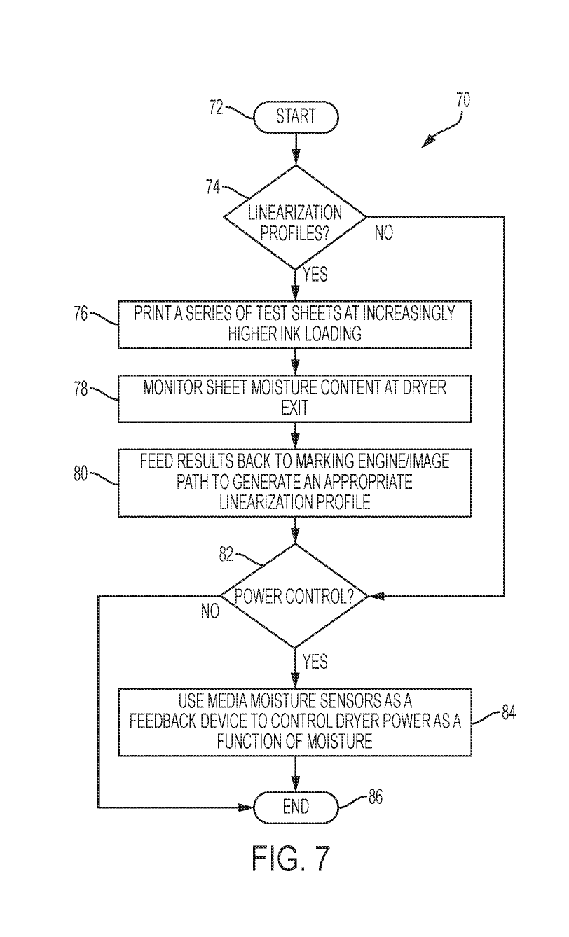

FIG. 7 illustrates a high-level flow chart of operations depicting logical operational steps of a method 70 for ensuring drying in a digital printing system such as system 100, in accordance with an example embodiment. The method 70 provides a process for in-situ monitoring of media moisture content to allow both active dryer power setting control and the ability to construct ink limiting linearization profiles for specific media types by users (e.g., customers) in real time.

As indicated at block 72, the process begins. As shown next at decision block 74, a step or operation can be implemented to determine if operations for generating linearization profiles are to be initiated. If so, then as depicted at block 76, for the case of generating linearization profiles, a series of test sheets can be printed at increasingly higher ink loading. As the sheets are printed, the sheet moisture content can be monitored (e.g., via the probes discussed previously) at the dryer exit to determine the point at which the dryer would no longer be able to effectively dry the sheets, as indicated at block 78. Then, as shown at block 80, the resulting information can be back to the marking engine/image path to generate an appropriate linearization profile. At this point in the process, the steps or operations for generating linearization profiles are now finished.

In the case of power control, a test or operation can be implemented, as indicated at decision block 82, to determine whether or not to proceed with the power control operations. If so, then as indicated at block 84, the media moisture sensors (e.g., such as the probes discussed previously) installed at the entrance and exit of each dryer zone are used as a feedback device to control the dryer power as a function of moisture. The process then ends, as indicated at block 86.

This approach thus offers the ability for a user or customer to generate ink volume limiting linearization tables in-situ to accommodate a wide range of media types and operating conditions. Also, actively controlling dryer power can reduce run costs because conventional dryers are sized and set to accommodate a worst-case dryer loading. This approach offers a non-contact means of measurement, which when interfaced with machine functions can result in enhanced performance and product output.

As can be appreciated by one skilled in the art, example embodiments can be implemented in the context of a method, data processing system, or computer program product. Accordingly, embodiments may take the form of an entirely hardware embodiment, an entirely software embodiment or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (for example, through the Internet utilizing an Internet Service Provider).

The disclosed example embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. In this regard, a high speed printing system may be considered a special-purpose computer designed with the specific purpose of rendering or printing documents.

The aforementioned computer program instructions may also be stored in a computer-readable memory (e.g., such as memory 104) that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 8-9 are shown only as exemplary diagrams of data-processing environments in which example embodiments may be implemented. It should be appreciated that FIGS. 8-9 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 8, some embodiments may be implemented in the context of a data-processing system 400 that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc) and/or other peripheral connections and components. Note that in some example embodiments, the USB connection 347 may couple or connect electronically with a printer such as the example digital printing system 100 disclosed herein.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc).

FIG. 9 illustrates a computer software system 450 for directing the operation of the data-processing system 400 depicted in FIG. 8. Software application 454, stored for example in memory 342 or another memory such as memory 104 shown in FIG. 3, generally includes one or more modules such as module 452. The computer software system 450 also includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein (e.g., the instructions/operations of method 70 shown at blocks 72 to 86 in FIG. 7). Module 452 may also be composed of a group of modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. In some example embodiments, the term “module” can also refer to a modular hardware component or a component that is a combination of hardware and software. The sheet feed module 106 discussed herein with respect to FIGS. 1-3 is an example of a hardware module that is operable according to specific instructions provided by a software module. Thus, the sheet module 106 can be implemented as a module based on both hardware and software.

FIGS. 8-9 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

Based on the foregoing, it will be appreciated that a number of example embodiments (e.g., preferred and alternative embodiments), are disclosed herein. For example, in a preferred embodiment, a method for facilitating drying of media in a high-speed digital printer, can be implemented. Such a method can include steps, instructions or operations such as, for example, rendering via the high-speed digital printer, a series of test media at an increasingly higher ink loading, the high-speed digital printer including a dryer module comprising a plurality of dryers that dry media including the test media; monitoring a moisture content of the test media at each exit of each of the plurality of dryers to determine data indicative of a threshold at which the dryer module is no longer able to effectively dry the test media; and feeding the data to a marking engine and/or image path of the high-speed digital printer to generate a linearization profile in-situ, wherein the linearization profile includes ink volume limiting linearization data that is used to ensure that media exiting the dryer module are dry.

In another example embodiment, a step or operation can be provided for controlling power in the high-speed digital printer as a function of moisture based on feedback signals from a plurality of media moisture sensors. Additionally, in some example embodiments, at least one respective media moisture sensor among the plurality of media moisture sensors can be installed a respective entrance and a respective exit of each dryer among the plurality of dryers. In a preferred embodiment, the aforementioned high-speed digital printer comprises a cut-sheet aqueous ink jet printing system.

In still another example embodiment, the ink volume limiting linearization data can include at least one ink volume limiting linearization table that tracks linearization data and accommodates a range of varying types of the media and operating conditions associated with the high-speed digital printer. In yet another example embodiment, the aforementioned plurality of dryers of the dryer module can be configured to include at least three (i.e., three or more) dryers.

In another example embodiment, system for facilitating drying of media in a high-speed digital printer, can be implemented. Such a system can include, for example, a high-speed digital printer that renders a series of test media at an increasingly higher ink loading, the high-speed digital printer including a dryer module comprising a plurality of dryers that dry media including the test media. The moisture content of the test media can be monitored at each exit of each of the plurality of dryers to determine data indicative of a threshold at which the dryer module is no longer able to effectively dry the test media. In addition, the data can be fed to a marking engine and/or image path of the high-speed digital printer to generate a linearization profile in-situ, wherein the linearization profile includes ink volume limiting linearization data that is used to ensure that media exiting the dryer module are dry.

In addition, in some example embodiments, a controller can be configured for controlling power in the high-speed digital printer as a function of moisture based on feedback signals from a plurality of media moisture sensors. In some example embodiments, the at least one respective media moisture sensor among the plurality of media moisture sensors can be installed a respective entrance and a respective exit of each dryer among the plurality of dryers.

In yet another example embodiment, a system for facilitating drying of media in a high-speed digital printer, can be implemented. Such a system can include, for example, at least one processor, and a non-transitory computer-usable medium embodying computer program code. The computer-usable medium is capable of communicating with the at least one processor, and the computer program code can include instructions executable by the at least one processor and configured for: rendering via the high-speed digital printer, a series of test media at an increasingly higher ink loading, the high-speed digital printer including a dryer module comprising a plurality of dryers that dry media including the test media; monitoring a moisture content of the test media at each exit of each of the plurality of dryers to determine data indicative of a threshold at which the dryer module is no longer able to effectively dry the test media; and feeding the data to a marking engine and/or image path of the high-speed digital printer to generate a linearization profile in-situ, wherein the linearization profile includes ink volume limiting linearization data that is used to ensure that media exiting the dryer module are dry.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for facilitating drying of media in a high-speed digital printer, said method comprising:
rendering via a said high-speed digital printer, a series of test media at an increasingly higher ink loading with an ink amount as a part of a calibration sequence, said high-speed digital printer comprising a digital printing press that includes a transport, a sheet feed module, a print head and ink module, a production stacker and a dryer module, said including a dryer module comprising a plurality of dryers that dry media including said test media, and said print head and ink module implemented in a print zone that includes a print head array and a group of associated print heads and inks of different colors;
monitoring with at least one media sensor among a plurality of sensors, a moisture content of said test media at each exit of each of said plurality of dryers to determine data indicative of a threshold at which said dryer module is no longer able to effectively dry said test media; and
feeding said data to a marking engine and/or an image path of said high-speed digital printer to generate in-situ a linearization profile in situ, wherein said linearization profile includes ink volume limiting linearization data that is used to ensure that media exiting said dryer module are dry, wherein said calibration sequence progressively puts down more ink on said test media until said at least one media sensor communicates that the dryer module is unable to dry said test media, which fixes a maximum ink amount with respect to said test media such that said ink amount is then backed down from said maximum ink amount to optimize an image quality via the linearization profile.

2. The method of claim 1 further comprising controlling power in said high-speed digital printer based on results from said calibration sequence and as a function of moisture based on feedback signals from said at least one media sensor, wherein said at least one media sensor comprises at least one media moisture sensor and an optical sensor.

3. The method of claim 2 wherein:
said at least one media sensor among said plurality of media sensors is installed at a respective entrance and at a respective exit of each dryer among said plurality of dryers;
said at least one media sensor further comprises a probe comprising a non-contact eddy probe that measures a sheet resistance across said media;
said optical sensor comprises a linear array of photo detectors and a light source; and
said sheet feed module comprising at least one feeder, where said at least one feeder includes a shuttle vacuum head to pick a sheet off of a stack of sheets and deliver said sheet to said transport.

4. The method of claim 1 further comprising controlling power in said high-speed digital printer as a function of moisture based on feedback signals from a plurality of media moisture sensors wherein at least one respective media moisture sensor among said plurality of media moisture sensors is installed a respective entrance and a respective exit of each dryer among said plurality of dryers.

5. The method of claim 1 wherein said high-speed digital printer comprises a cut-sheet aqueous ink jet printing system.

6. The method of claim 1 wherein said ink volume limiting linearization data comprises at least one ink volume limiting linearization table that tracks linearization data and accommodates a range of varying types of said media and operating conditions associated with said high-speed digital printer.

7. The method of claim 1 further comprising configuring said plurality of dryers of said dryer module to comprise at least three dryers.

8. A system for facilitating drying of media in a high-speed digital printer, said system comprising:
a high-speed digital printer that renders a series of test media at an increasingly higher ink loading with an ink amount as a part of a calibration sequence, said high-speed digital printer including a digital printing press that includes a transport, a sheet feed module, a print head and ink module, a production stacker and a dryer module, said dryer module comprising a plurality of dryers that dry media including said test media, and said print head and ink module implemented in a print zone that includes a print head array and a group of associated print heads and inks of different colors;
at least one media sensor that monitors a moisture content of said test media at each exit of each of said plurality of dryers to determine data indicative of a threshold at which said dryer module is no longer able to effectively dry said test media;
a controller that controls operations of said at least one media sensor and a power control of said high-speed digital printer and print zones within the high-speed digital printer, wherein said at least one media sensor is operatively connected to said controller; and
wherein said data is fed to a marking engine and/or an image path of said high-speed digital printer to generate in-situ a linearization profile, wherein said linearization profile includes ink volume limiting linearization data that is used to ensure that media exiting said dryer module are dry, wherein said calibration sequence progressively puts down more ink on said test media until said at least one media sensor communicates that the dryer module is unable to dry said test media, which fixes a maximum ink amount with respect to said test media such that said ink amount is then backed down from said maximum ink amount to optimize an image quality via the linearization profile.

9. The system of claim 8 wherein said at least one media sensor comprises at least one optical sensor among a plurality of optical sensors and at least one media moisture sensor among a plurality of media moisture sensors and wherein said controller is configured to control said power in said high-speed digital printer based on results from said calibration sequence and as a function of moisture based on feedback signals from said plurality of media moisture sensors.

10. The system of claim 9 wherein:
said at least one media sensor further includes an optical sensor comprising a linear array of photo detectors and a light source;
said controller is further configured to control at least one print head in said print head array and among said group of associated print heads in said high-speed digital printer and receive signals generated by said at least one media sensor and analyze said signals to detect an improper ejection of ink drops and identify at least one print head in said print head array and among said group of associated print heads in said high-speed digital printer responsible for said improper ejection of ink drops.

11. The system of claim 8 further comprising a controller for controlling power in said high-speed digital printer as a function of moisture based on feedback signals from a plurality of media moisture sensors, and wherein at least one respective media moisture sensor among said plurality of media moisture sensors is installed a respective entrance and a respective exit of each dryer among said plurality of dryers.

12. The system of claim 8 wherein said high-speed digital printer comprises a cut-sheet aqueous ink jet printing system.

13. The system of claim 8 wherein said ink volume limiting linearization data comprises at least one ink volume limiting linearization table that tracks linearization data and accommodates a range of varying types of said media and operating conditions associated with said high-speed digital printer.

14. The system of claim 8 further wherein said plurality of dryers of said dryer module is configured to comprise at least three dryers.

15. A system for facilitating drying of media in a high-speed digital printer, said system comprising:
at least one processor; and
a non-transitory computer-usable medium embodying computer program code, said computer-usable medium capable of communicating with said at least one processor, said computer program code comprising instructions executable by said at least one processor and configured for:
rendering via a high-speed digital printer, a series of test media at an increasingly higher ink loading with an ink amount as a part of a calibration sequence, said high-speed digital printer comprising a digital printing press that includes a transport, a sheet feed module, a print head and ink module, a production stacker and a dryer module, said dryer module comprising a plurality of dryers that dry media including said test media, and said print head and ink module implemented in a print zone that includes a print head array and a group of associated print heads and inks of different colors;
monitoring a moisture content of said test media with at least one media sensor at each exit of each of said plurality of dryers to determine data indicative of a threshold at which said dryer module is no longer able to effectively dry said test media; and
feeding said data to a marking engine and/or an image path of said high-speed digital printer to generate in-situ a linearization profile, wherein said linearization profile includes ink volume limiting linearization data that is used to ensure that media exiting said dryer module are dry, wherein said calibration sequence progressively puts down more ink on said test media until said at least one media sensor communicates that the dryer module is unable to dry said test media, which fixes a maximum ink amount with respect to said test media such that said ink amount is then backed down from said maximum ink amount to optimize an image quality via the linearization profile.

16. The system of claim 15 further comprising a controller that communicates electronically with said at least one processor, wherein said controller controls power in said high-speed digital printer based on results from said calibration sequence and as a function of moisture based on feedback signals from said at least one media sensor, wherein said at least one media sensor comprises at least a moisture sensor and an optical sensor operative connected to said controller.

17. The system of claim 16 wherein:
at least one respective media sensor among said plurality of media moisture sensors is installed at a respective entrance and at a respective exit of each dryer among said plurality of dryers;
said optical sensor further includes a linear array of photo detectors and a light source;
said controller is further configured to control at least one print head in said print head array and among said group of associated print heads in said high-speed digital printer and receive signals generated by said at least one media sensor and analyze said signals to detect an improper ejection of ink drops and identify at least one print head in said print head array and among said group of associated print heads in said high-speed digital printer responsible for said improper ejection of ink drops; and
said sheet feed module comprises at least one feeder, where said at least one feeder includes a shuttle vacuum head to pick a sheet off of a stack of sheets and deliver said sheet to said transport.

18. The system of claim 8 further comprising a controller for controlling power in said high-speed digital printer as a function of moisture based on feedback signals from a plurality of media moisture sensors, and wherein at least one respective media moisture sensor among said plurality of media moisture sensors is installed a respective entrance and a respective exit of each dryer among said plurality of dryers.

19. The system of claim 8 wherein said ink volume limiting linearization data comprises at least one ink volume limiting linearization table that tracks linearization data and accommodates a range of varying types of said media and operating conditions associated with said high-speed digital printer.

20. The system of claim 8 further comprising wherein said plurality of dryers of said dryer module comprises at least three dryers.
